(19) United States
(12) Patent Application Publication
(10) Pub. No.: US 2010/0270482 A1
(43) Pub. Date: Oct. 28, 2010

(54) Storage-transport system and method for storing and transporting radioactive waste

(75) Inventors: Werner Werschnik, Russelsheim (DE); Michael Freiman, Konigstein (DE); Viktor Gliha, Hanau (DE)

Correspondence Address: LERNER GREENBERG STEMER LLP, P O BOX 2480, HOLLYWOOD, FL, 33022-2480, US

(73) Assignee: Framatome ANP GmbH

(21) Appl. No.: 11/502,329

(22) Filed: Aug. 10, 2006

Related U.S. Application Data
(63) Continuation of application No. PCT/EP05/00786, filed on Jan. 27, 2005.

(30) Foreign Application Priority Data
Feb. 10, 2004 (DE) 10 2004 006 620.5

(51) Int. Cl. G21F 5/005; G21F 5/14; G21F 5/12

(52) U.S. Cl. 250/507.1; 250/506.1

(57) ABSTRACT

A storage-transport system includes a storage container and a transport container for respectively storing and transporting weak to intermediate level active nuclear waste. The storage-transport system has different containers for the functions of storage and transport, namely the storage container and the transport container. The storage container only meets the requirements for temporary storage which are less strict than the requirements for the transport container, thereby allowing for a simple and therefore less expensive construction of the storage container. A method for storing and for transporting radioactive waste is also provided.

### CROSS-REFERENCE TO RELATED APPLICATIONS

This is a continuing application, under 35 U.S.C. §120, of copending International Application No. PCT/EP2005/000786, filed Jan. 27, 2005, which designated the United States; this application also claims the priority, under 35 U.S.C. §119, of German Patent Application DE 10 2004 006 620.5, filed Feb. 10, 2004; the prior applications are herewith incorporated by reference in their entirety.

### BACKGROUND OF THE INVENTION

### Field of the Invention

The invention relates to a storage-transport system and to a method for storing and for transporting radioactive waste.

Following cost-effective use of radioactive materials, the latter have to be disposed of in a suitable manner due to their residual radiation and long half-lives. Considerable quantities of radioactive waste are produced, in particular in the case of energy being generated through the use of nuclear power. In addition to spent fuel elements, those quantities of radioactive waste also include low-level and medium-level radioactive waste, for example contaminated operating equipment. Liquid radioactive waste is often cast, in a cementation installation, into a solid mass which is introduced, for example, into drums.

Safe storage of the waste has to be ensured due to the very long half-lives. At present, in Germany, the radioactive waste is stored in interim storage facilities over a period of a number of years until being transported, at the end of that period, into a yet-to-be-determined final storage facility.

It is thus necessary for those containers, into which the radioactive waste has been introduced, to meet requirements with respect to storage both in the interim storage facility and in the final storage facility, as well as requirements with respect to necessary transportation, for example between the interim storage facility and the final storage facility. As a result, the containers have to meet very stringent requirements overall both with respect to providing shielding for radiation of the radioactive waste located in the container and with respect to a sufficiently high level of transportation safety, for example by way of sufficiently high mechanical stability, in order to reliably avoid the leakage of radioactivity in the event of an accident during transportation. Furthermore, the containers have to be constructed so as to be capable of transportation and handling. Those requirements render current transporting and storage containers highly complex and correspondingly expensive.

### SUMMARY OF THE INVENTION

It is accordingly an object of the invention to provide a storage-transport system and a method for storing and for transporting radioactive waste, which overcome the hereinafore-mentioned disadvantages of the heretofore-known devices and methods of this general type and which allow simplified and more cost-effective storage and simplified and more cost-effective transportation, in particular of low-level and medium-level radioactive waste.

With the foregoing and other objects in view there is provided, in accordance with the invention, a storage-transport system for storing and for transporting radioactive waste. The transport system comprises a storage container for accommodating the radioactive waste. The storage container meets relatively less stringent requirements regarding shielding capacity against radioactive radiation for storage in a storage facility, in particular an interim storage facility, but does not meet relatively more stringent requirements for transportation outside the storage facility. The storage container is configured for placement in a transport container meeting the relatively more stringent transportation requirements for transportation outside the storage facility.

This configuration is based on the concept of taking into account the different requirements with respect to storage and transportation of the storage and transportation functions of a container for radioactive waste being separated and divided between two containers constructed to meet different requirements. To be precise, a specific storage container which, for transportation, is transported into a suitable transport container is provided. Due to the more low-level requirements with respect to storage in the interim storage facility, this measure allows the storage container to have a considerably more straightforward and, in particular, more cost-effective construction than is possible for the current conventional containers, which are constructed both for storage and for transportation purposes.

Separating the storage and transportation functions, in addition, makes it possible to select different storage systems for the final storage facility. Since the interim storage facilities are constructed, for example, for a half-life of 30 years, it is thus possible to take into account technical developments and findings for final storage purposes.

In particular, the containers have to meet requirements, on one hand, with respect to providing shielding for the radioactive radiation and, on the other hand, with respect to mechanical stability. Both requirements are usually considerably less stringent in the interim storage facility since, for example, in comparison with transportation, there is no risk of an accident during storage (mechanical stability). It is also the case that the interim storage facility itself, which is in the form of a dedicated part of a building, for example directly on the grounds of a nuclear plant, provides shielding for the radioactive radiation, whereas during transportation, the container comes into direct contact with the environment and thus has to provide better shielding than in the interim storage facility. The containers in this case have to be constructed in such a way that a maximum admissible radiation-dose output is not exceeded.

In accordance with another feature of the invention, the storage container is constructed merely for complying with a relatively high maximum admissible radiation-dose output in the interim storage facility, but not for complying with a relatively low maximum admissible radiation-dose output outside the interim storage facility. It is only by placing the storage container in the transport container that the radiation-dose output also drops below the relatively low maximum admissible value outside the interim storage facility.

In accordance with a further feature of the invention, the storage container is provided for accommodating a plurality of receptacles with radioactive waste, in particular for accommodating drums. This simplifies the handling of the receptacles and allows the latter to be handled together. It is also possible, if required, to provide for additional measures for shielding purposes and for increasing the mechanical stability. Thus, for example, for final storage purposes, the receptacles stored in the storage container are preferably cast in place in the storage container. In an alternatively advantageous configuration, without reverting to the use of receptacles, the storage container is provided for accommodating solid radioactive waste.

In accordance with an added feature of the invention, in order to ensure accessibility to the individual receptacles, in particular drums, in the storage container, the storage container is closed merely by a loosely or releasably disposed cover. This measure thus makes it possible, at any time, to remove the cover and, for example, automatically inspect and monitor the stored drums. Furthermore, it is also possible to handle the individual receptacles. In particular, the configuration with the loose cover makes it possible, for final storage purposes, for the individual receptacles to be stored in accordance with the most recent technological findings.

In accordance with an additional feature of the invention, in order to provide storage in the interim storage facility which is as space-saving and stable as possible, the storage container preferably has a stackable construction. For this purpose, the container has, for example, a rectangular cross section and, on its underside, feet and, on the top side, mounts or guides for the feet of a further storage container, as is provided in conventional stacking containers.

In accordance with yet another feature of the invention, the storage container is constructed in such a way that its side walls and its base are formed of a concrete structure or of steel. The concrete structure may be provided with corresponding reinforcement. The concrete structure makes it possible, straightforwardly and cost-effectively, to achieve both good shielding and sufficient mechanical stability for storage purposes. In this case, however, the wall thicknesses are smaller than in the case of a container constructed for transportation purposes.

In accordance with yet a further feature of the invention, in order to keep the costs low, the transport container is constructed for repeated transportation of storage containers. Only a small number of transport containers is required by virtue of it being possible to reuse the transport container. Correspondingly, it is possible for the transport container to be very complex and constructed to meet highly stringent safety requirements without this having a marked influence on the costs for the storage-transport system overall. It is expedient, for repeated loading and unloading of the transport container, for the latter to be configured with a container cover which, in particular, can be motor-actuated and closed repeatedly.

In accordance with yet an added feature of the invention, in order for the storage container to fit as closely, and thus reliably, as possible in the transport container, the internal dimensions of the transport container are adapted to the external dimensions of the storage container. In order for the storage container to be straightforwardly introduced and securely retained, guides which are constructed, in particular, in the manner of profiles or strips are preferably provided, in addition, on the walls of the transport container. These guides allow the storage container to be retained in the transport container, as far as possible, in a play-free manner. The guides preferably have introduction slopes for easy introduction.

In accordance with yet an additional feature of the invention, the transport container is constructed as a steel container from a suitable steel with a high shielding capacity and high mechanical stability.

With the objects of the invention in view, there is also provided a method for storing and for transporting radioactive waste. The method comprises providing a storage container meeting relatively less stringent requirements regarding shielding capacity against radioactive radiation for storage in a storage facility, in particular an interim storage facility, but not meeting relatively more stringent requirements for transportation outside the storage facility. The radioactive waste is introduced into the storage container. The storage container is positioned in the storage facility. The storage container is placed in a transport container meeting the relatively more stringent transportation requirements for transportation outside the storage facility.

The preferred configurations and advantages which have been cited with respect to the storage-transport system can also be applied analogously to the method.

Other features which are considered as characteristic for the invention are set forth in the appended claims.

Although the invention is illustrated and described herein as embodied in a storage-transport system and a method for storing and for transporting radioactive waste, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partly-sectional, side-elevational view of a storage container according to the invention with a cover provided for loose placement in position;

FIG. 2 is a further partly-sectional, side-elevational view of the storage container according to FIG. 1;

FIG. 3 is a plan view of the storage container according to FIGS. 1 and 2, indicating section lines I-I of FIG. 1 and II-II of FIG. 2;

FIG. 4 is a perspective view of a transport container;

FIG. 5 is a side-elevational view of the transport container according to FIG. 4, with a diagrammatically illustrated driver's cab of a truck; and

FIG. 6 is a block diagram demonstrating disposal of radioactive waste.

### DESCRIPTION OF THE PREFERRED EMBODIMENTS

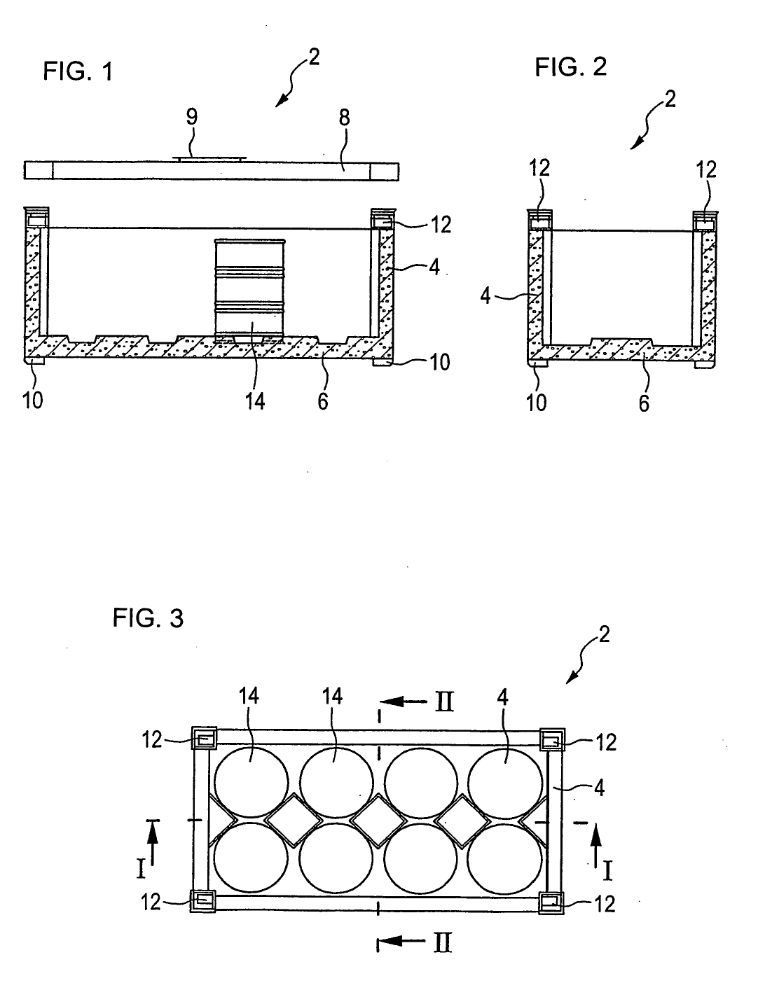

Referring now to the figures of the drawings in detail and first, particularly, to FIGS. 1-3 thereof, there is seen a storage container 2 which is constructed in such a way that its side walls 4, together with its base 6, are formed of a single-piece concrete structure. A cover 8, which is preferably likewise made of concrete, is provided with a gripping device 9 for the purpose of closing the storage container 2. The cover 8 is merely placed loosely in position on the side walls 4 for the purpose of closing the storage container 2. The storage container 2 has a rectangular outline and a stackable construction. For this purpose, feet 10 are disposed at four corner points on the underside of the base 6. The side walls 4 each carry mounts or guides 12 on their top end side at the four corners. The feet 10 of a further storage container 2 are introduced into these mounts or guides during stacking of this further storage container.

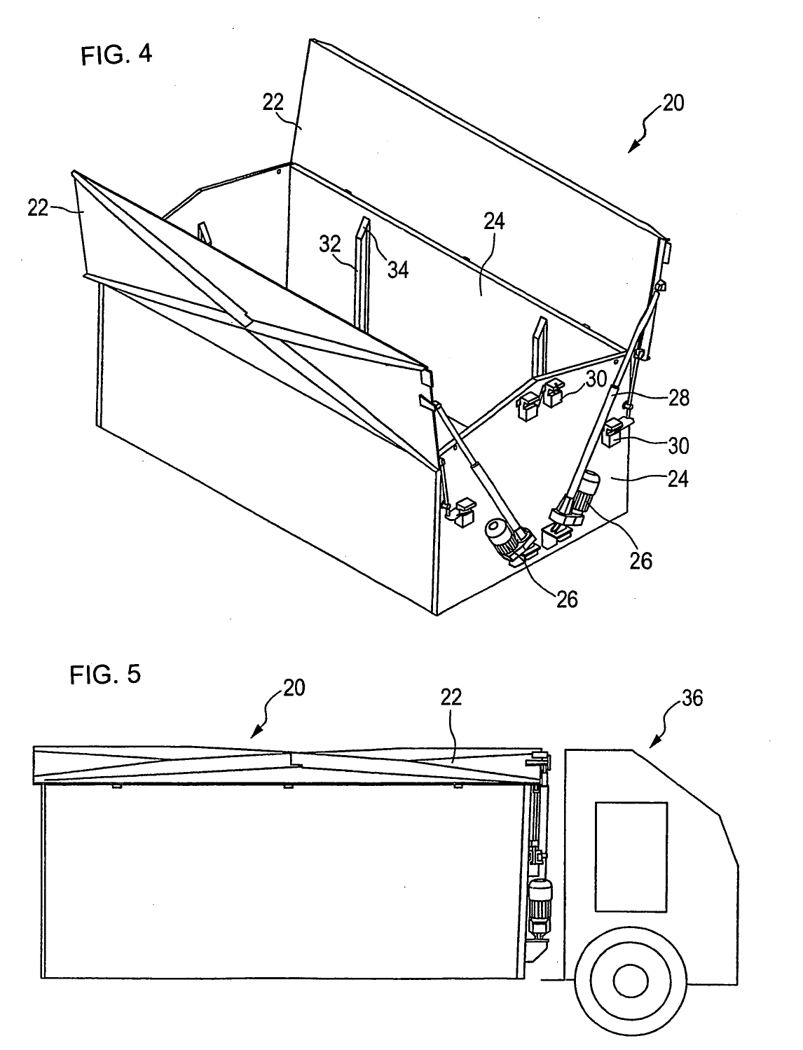

In the exemplary embodiment, the storage container 2 is provided for accommodating a total of 8 radioactive receptacles in the form of drums 14. In order to prevent the drums 14 from slipping, the base 6 has a profile construction on its top side and has, in particular, rhomboidal elevations, resulting in the formation of a total of 8 separate accommodating spaces for the drums 14, as is seen in FIG. 3.

A transport container 20, which can be seen in FIGS. 4 and 5 in particular, is adapted specifically for transportation within the grounds of a power station. In the exemplary embodiment, it is constructed as a steel container and can be closed by a double-wing container cover 22. Two motors 26 are provided on an outer end side of a side wall 24 of the container for the purpose of reversible opening and closing. These motors 26 are each connected, through an extensible linkage 28, to a respective wing of the container cover 22 in order for the wing to be reversibly opened and closed.

Locking and securing devices 30 for the container cover 22 are also disposed on the side wall 24 of the container.

Guide profiles 32 in the interior of the container are fastened on the side walls 24 of the container. These guide profiles 32 have an introduction slope 34 on their top end side. The internal dimensions of the transport container 20 are such that the storage container 2, which has been 1) described in relation to FIGS. 1-3, fits as closely as possible between the guide profiles 32. The introduction slope 34 makes it easier for the storage container 2 to be introduced. This introduction slope, at the same time, also provides for automatic alignment and centering of the storage container 2.

The transport container 20 is provided for transportation through the use of a truck 36, of which the driver's cab is illustrated diagrammatically in FIG. 5. The transport container 20 in this case is connected to the truck by suitable screw connections or other types of releasable connections or else in a non-releasable manner by welding.

The storage container 2 and the transport container 20 form part of a common concept for storing and for transporting low-level and medium-level radioactive waste. The important factor in this concept is to be seen in the fact that the storage and transportation functions are divided between two different container combinations. Thus, on one hand, the storage container 2 is constructed merely for storage, in particular in a non-illustrated interim storage facility, whereas the transportation function is performed by the transport container 20 combined with the storage container 2 introduced therein. Different regulations and requirements apply for the storage of radioactive waste in an interim storage facility and for the transportation of radioactive waste, not in the least because of legal requirements. Since a building which forms the interim storage facility also performs a shielding function with respect to the surroundings and, in addition, there is no transportation-related accident risk, the requirements with respect to storage in the interim storage facility are considerably less stringent than the requirements which have to be met by the transport container. Accordingly, the storage container 2 is constructed merely to meet the requirements which apply to the interim storage facility. In comparison with a transport container constructed for transportation purposes, this is manifested by a lower shielding capacity and, in addition, also by a lower level of sealing and mechanical stability. The storage container 2 is thus configured in such a way that, when a radioactive waste with a certain initial level of radioactivity is stored therein, the radiation-dose output drops below the maximum admissible value which applies to the interior of the interim storage facility, but does not drop below the lower, and thus more critical, maximum admissible value outside the interim storage facility.

The shielding capacity of the storage container 2 is determined substantially by the material selected for the side walls 4, the base 6 and the cover 8 and by the density of the material and the wall thickness. The configuration of the storage container 2 in order to meet the more low-level requirements within the interim storage facility is manifested, for example, in such a way that, in each case in comparison with a container which also has to meet transportation requirements:

a) if use is made of the same material, the wall thickness is smaller,
b) if use is made of the same material, the latter may have a lower density, and
c) use can be made, overall, of a more cost-effective material with a lower shielding capacity and/or lower mechanical stability.

In particular, this gives rise to considerable cost-saving opportunities in comparison with a container which is constructed both as a storage and as a transport container.

In the exemplary embodiment of FIGS. 1-3, the storage container 2 is constructed as a concrete container. It is also possible for the storage container 2 to be formed of some other material or material mix and to be constructed, for example, as a steel container.

The more stringent requirements with respect to transportation are manifested, for example, in the above-mentioned lower maximum admissible radiation-dose output and in the more stringent requirements which have to be met by the mechanical stability in order to take into account the greater risk of an accident during transportation. The more stringent transportation requirements are met by the transport container 20 combined with the storage container 2 inserted therein. It is also possible for the transport container 20 to already be constructed in such a way that it alone meets the transportation requirements so that, in principle, it would also be possible for receptacles containing the radioactive waste to be introduced loosely into the transport container 20.

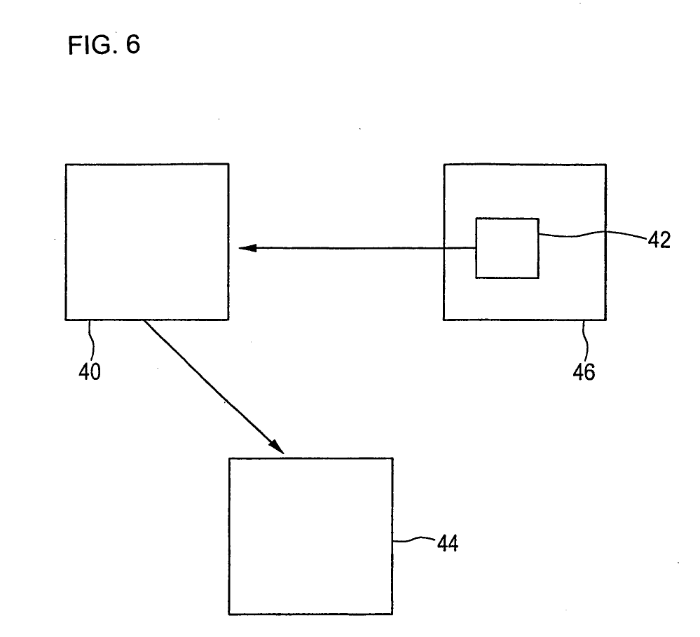

The transport container 20 basically serves for transportation purposes within the power-station grounds. In contrast, in order to transport the storage container 2 outside an interim storage facility 40, for example for transporting the storage container 2 from an installation for conditioning the radioactive waste, such as a cementation installation 42, into the interim storage facility 40, as well as for transporting the storage container from the interim storage facility 40 into a final storage facility 44, as is diagrammatically illustrated in simplified form in FIG. 6, or for other transporting trips on public roads, a transport container which meets the requirements stipulated by IAEA is provided. The conditioning installation 42 is illustrated in this case as part of a nuclear plant 46. The interim storage facility 40 may be a specific building on the grounds of the nuclear plant.

During operation of the nuclear plant 46, in particular for generating energy (nuclear power station), both solid and liquid low-level and medium-level radioactive waste is produced and has to be disposed of in a suitable manner. In particular in the case of liquid waste, provision is often made for such waste to be mixed with a suitable cement mass in the cementation installation 42 and introduced into the above-mentioned drums 14, in which the mass then solidifies. These drums 14 which are filled in the cementation installation 42 are inserted into the storage container 2, and the storage container 2 is then inserted into the transport container 20 and transported into the interim storage facility 40, where the storage container 2 is lifted out of the transport container 20 again and positioned in a storage location envisaged therefor. Respectively suitable cranes or lifting apparatuses are provided for handling the drums 14 and the storage container 2, in the process of which they grip the drums 14 and/or the storage container 2 at suitable locations.

The cover 8 of the storage container 2 need only be placed in position loosely, not in the least because of the relatively low-level requirements in the interim storage facility 40. This provides the advantage that, during the storage period in the interim storage facility, it is possible for the cover 8 to be easily removed and for the drums 14 stored therein to be inspected and monitored and exchanged, if required, for example in the event of leakage. The cover 8 has the gripping device 9 on its top side for the purpose of handling the same.

A further significant advantage of the cover 8 only being loosely or releasably placed in position is that there is no need to decide on the method of conditioning the radioactive waste at the interim storage stage. Rather, the option for the definitive conditioning method remains open until the radioactive waste is moved into the final storage facility 44. Since the interim storage facility 40 is constructed, for example, for storing waste over a period of 30 years, that is to say a number of decades can elapse before the waste is transported into the final storage facility 44, this measure makes it possible to take into account future technological developments or findings for definitive conditioning. This is particularly advantageous since the storage container 2 can be used not just for accommodating drums 14 but also for accommodating loose radioactive waste. A comparatively straightforward conditioning method for the final storage facility 44 is that of using a suitable cement mass to fill the storage container 2, with the drums 14 stored therein.

1. A storage-transport system for storing and for transporting radioactive waste, the transport system comprising:
a storage container for accommodating the radioactive waste; and
a cover loosely placed on said storage container to close said storage container;
said storage container meeting relatively less stringent requirements regarding shielding capacity against radioactive radiation for storage in a storage facility, but not meeting relatively more stringent requirements for transportation outside the storage facility; and
said storage container being configured for placement in a transport container meeting the relatively more stringent transportation requirements for transportation outside the storage facility.

2. The storage-transport system according to claim 1, wherein said storage facility is an interim storage facility.

3. The storage-transport system according to claim 2, wherein said storage container is constructed merely for complying with a relatively high maximum admissible radiation-dose output in the interim storage facility, but not for complying with a relatively low maximum admissible radiation-dose output outside the interim storage facility.

4. The storage-transport system according to claim 1, wherein said storage container does not meet predetermined transportation requirements for mechanical stability.

5. The storage-transport system according to claim 1, wherein said storage container is configured for accommodating a plurality of receptacles with radioactive waste.

6. The storage-transport system according to claim 5, wherein said receptacles are drums.

7. The storage-transport system according to claim 1, wherein said storage container is configured for accommodating solid radioactive waste.

8. (canceled)

9. The storage-transport system according to claim 1, wherein said storage container is stackable with other storage containers.

10. The storage-transport system according to claim 1, wherein said storage container has side walls and a base formed of a material selected from the group consisting of concrete and steel.

11. The storage-transport system according to claim 1, which further comprises a transport container for accommodating said storage container, said transport container being constructed to meet the relatively more stringent transportation requirements.

12. The storage-transport system according to claim 11, wherein said transport container is constructed for repeated transportation of storage containers.

13. The storage-transport system according to claim 12, wherein said transport container has a container cover to be closed repeatedly.

14. The storage-transport system according to claim 13, wherein said container cover is motor-actuated.

15. The storage-transport system according to claim 11, wherein said storage container has external dimensions, and said transport container has internal dimensions adapted to said external dimensions of said storage container.

16. The storage-transport system according to claim 15, wherein said transport container has side walls and guide profiles disposed on said side walls for introduction and retention of said storage container.

17. The storage-transport system according to claim 11, wherein said transport container is a steel container.

18. A method for storing and for transporting radioactive waste, the method comprising the following steps:
providing a storage container meeting relatively less stringent requirements regarding shielding capacity against radioactive radiation for storage in a storage facility, but not meeting relatively more stringent requirements for transportation outside the storage facility;
introducing the radioactive waste into the storage container;
closing the storage container by loosely placing a cover on the storage container;
positioning the storage container in the storage facility; and
placing the storage container in a transport container meeting the relatively more stringent transportation requirements for transportation outside the storage facility.

19. The method according to claim 18, wherein the storage facility is an interim storage facility.

20-21. (canceled)
